(19) United States
(12) Patent Application Publication
(10) Pub. No.: US 2006/0256857 A1
(43) Pub. Date: Nov. 16, 2006

(54) Method and system for rate control in a video encoder

(76) Inventor: Douglas Chin, Haverhill, MA (US)

Correspondence Address: MCANDREWS HELD & MALLOY, LTD, 500 WEST MADISON STREET, SUITE 3400, CHICAGO, IL, 60661, US

(21) Appl. No.: 11/408,321

(22) Filed: Apr. 21, 2006

Related U.S. Application Data
(60) Provisional application No. 60/681,635, filed on May 16, 2005.

(51) Int. Cl. H04N 11/04; H04B 1/66; H04N 11/02; H04N 7/12

(52) U.S. Cl. 375/240.03

(57) ABSTRACT

Presented herein are systems, methods, and apparatus for real-time high definition television encoding. In one embodiment, there is a method for encoding video data. The method comprises estimating amounts of data for encoding a plurality of pictures in parallel. A plurality of target rates are generated corresponding to the plurality of pictures and based on the estimated amounts of data for encoding the plurality of pictures. The plurality of pictures are then lossy compressed based on the target rates corresponding to the plurality of pictures.

### RELATED APPLICATIONS

This application claims priority to and claims benefit from: U.S. Provisional Patent Application Ser. No. 60/681,635, entitled “METHOD AND SYSTEM FOR RATE CONTROL IN A VIDEO ENCODER” and filed on May 16, 2005.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Advanced Video Coding (AVC) (also referred to as H.264 and MPEG-4, Part 10) can be used to compress digital video content for transmission and storage, thereby saving bandwidth and memory. However, encoding in accordance with AVC can be computationally intense.

AVC uses temporal coding to compress video data. Temporal coding divides a picture into blocks and encodes the blocks using similar blocks from other pictures, known as reference pictures. To achieve the foregoing, the encoder searches the reference picture for a similar block. This is known as motion estimation. At the decoder, the block is reconstructed from the reference picture. However, the decoder uses a reconstructed reference picture. The reconstructed reference picture is different, albeit imperceptibly, from the original reference picture. Therefore, the encoder uses encoded and reconstructed reference (predicted) pictures for motion estimation.

Using encoded and predicted pictures for motion estimation causes encoding of a picture to be dependent on the encoding of the reference pictures.

Additional limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Aspects of the present invention may be found in a system, method, and/or apparatus for controlling the bit rate while encoding video data, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of an exemplary system for encoding video data in accordance with an embodiment of the present invention;

FIG. 2 is a flow diagram for encoding video data in accordance with an embodiment of the present invention;

FIG. 3 is a block diagram of a system for encoding video data in accordance with an embodiment of the present invention;

FIG. 4 is a flow diagram for encoding video data in accordance with an embodiment of the present invention; and

FIG. 5 is a block diagram of an exemplary video classification engine in accordance with an embodiment of the present invention.

### DETAILED DESCRIPTION OF THE INVENTION

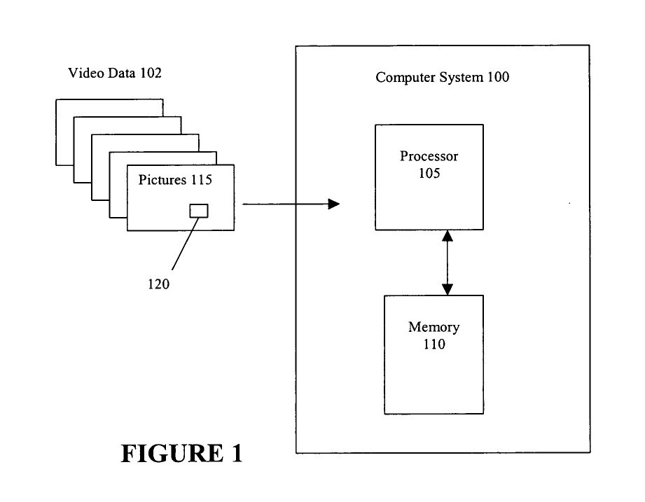

Referring now to FIG. 1, there is illustrated a block diagram of an exemplary system 100 for encoding video data in accordance with an embodiment of the present invention. The video data comprises pictures 115. The pictures 115 comprise portions 120. The portions 120 can comprise, for example, a two-dimensional grid of pixels.

The computer system 100 comprises a processor 105 and a memory 110 for storing instructions that are executable by the processor 105. When the processor 105 executes the instructions, the processor estimates an amount of data for encoding a portion of a picture.

The estimate of the amount of data for encoding a portion 120 of the picture 115 can be based on a variety of factors. In certain embodiments of the present invention, the estimate of the portion 120 of the picture 115 can be based on a comparison of the portion 120 of the picture 115 to portions of other original pictures 115. In a variety of encoding standards, such as MPEG-2, AVC, and VC-1, portions 120 of a picture 115 are encoded with reference to portions of other encoded pictures 115. The amount of data for encoding the portion 120 is dependent on the similarity or dissimilarity of the portion 120 to the portions of the other encoded pictures 115. Examining the original reference pictures 115 for the best portions and measuring the similarities or dissimilarities can estimate the amount of data for encoding the portion 120.

The estimated amount of data for encoding the portion 120 can also include, for example, content sensitivity, measures of complexity of the pictures and/or the blocks therein, and the similarity of blocks in the pictures to candidate blocks in reference pictures. Content sensitivity measures the likelihood that information loss is perceivable, based on the content of the video data. For example, in video data, loss is more noticeable in some types of texture than in others. In certain embodiments of the present invention, the foregoing factors can be used to bias the estimated amount of data for encoding the portion 120 based on the similarities or dissimilarities to portions of other original pictures.

Additionally, the computer system 100 receives a target rate for encoding the picture. The target rate can be provided by either an external system or the computer system 100 that budgets data for the video to different pictures. For example, in certain applications, it is desirable to compress the video data for storage to a limited capacity memory or for transmission over a limited bandwidth communication channel. Accordingly, the external system or computer system 100 budgets limited data bits to the video. Additionally, the amount of data encoding different pictures 115 in the video can vary. As well, based on a variety of characteristics, different pictures 115 and different portions 120 of a picture 115 can offer differing levels of quality for a given amount of data. Thus, the data bits can be budgeted accordingly to these factors.

In certain embodiments of the present invention, the system 100 can estimate amounts of data for encoding each of the portions 120 forming the picture 115. The target rate can be based on the estimated amounts of data for encoding each of the portions 120 forming the picture 115.

Based on the target rate for the pictures 115 and the estimated amount of data for encoding portions 120 of the picture, the picture is lossy encoded. The estimates are finding the relative bit distribution of where bits should go in each picture and between pictures. Lossy encoding involves trade-off between quality and compression. Generally, the more information that is lost during lossy compression, the better the compression rate, but, the more the likelihood that the information loss perceptually changes the portion 120 of the picture 115 and reduces quality.

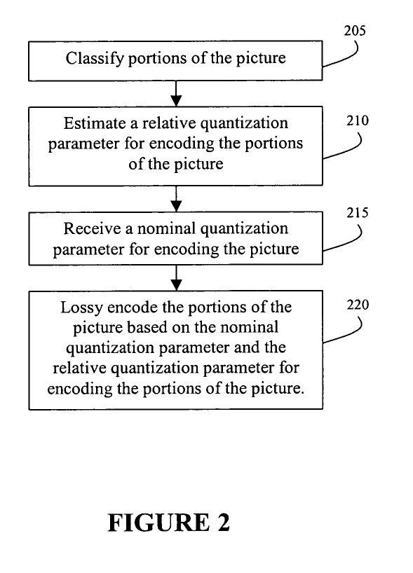

Referring now to FIG. 2, there is illustrated a flow diagram for encoding a picture in accordance with an embodiment of the present invention. At 205, portions of the picture are classified. At 210, a relative quantization parameter for encoding the portions of the picture is estimated. At 215, a nominal quantization parameter for encoding the picture is received. At 220, the portions of the picture are lossy encoded, based on the nominal quantization parameter and the relative quantization parameter for encoding the portion of the picture.

Embodiments of the present invention will now be presented in the context of an exemplary video encoding standard, Advanced Video Coding (AVC) (also known as MPEG-4, Part 10, and H.264). A brief description of AVC will be presented, followed by embodiments of the present invention in the context of AVC. It is noted, however, that the present invention is by no means limited to AVC and can be applied in the context of a variety of encoding standards.

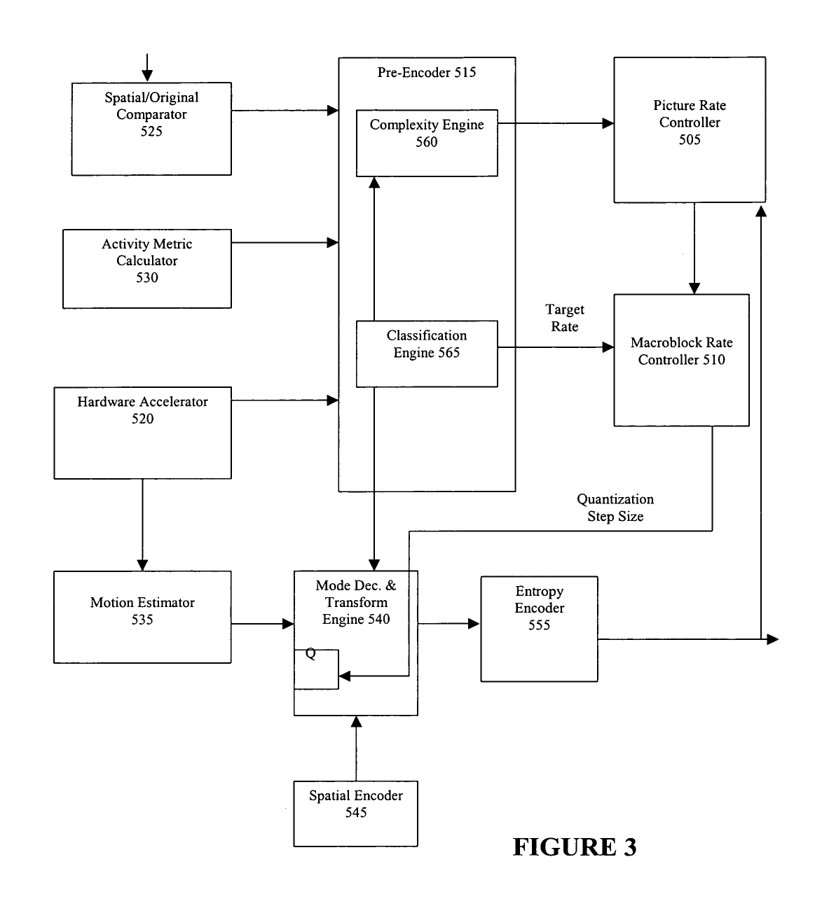

Referring now to FIG. 3, there is illustrated a block diagram of an exemplary system 500 for encoding video data in accordance with an embodiment of the present invention. The system 500 comprises a picture rate controller 505, a macroblock rate controller 510, a pre-encoder 515, hardware accelerator 520, spatial from original comparator 525, an activity metric calculator 530, a motion estimator 535, a mode decision and transform engine 540, and an entropy encoder 555.

The picture rate controller 505 can comprise software or firmware residing on an external master system. The macroblock rate controller 510, pre-encoder 515, spatial from original comparator 525, mode decision and transform engine 540, spatial predictor 545, and entropy encoder 555 can comprise software or firmware residing on computer system 100. The pre-encoder 515 includes a complexity engine 560 and a classification engine 565. The hardware accelerator 520 can either be a central resource accessible by the computer system 100 or at the computer system 100.

The hardware accelerator 520 can search the original predicted pictures for candidate blocks that are similar to blocks in the pictures 115 and compare the candidate blocks CB to the blocks in the pictures. The hardware accelerator 520 then provides the candidate blocks and the comparisons to the pre-encoder 515.

The spatial from original comparator 525 examines the quality of the spatial prediction of macroblocks in the picture, using the original picture and provides the comparison to the pre-encoder 515.

The pre-encoder 515 estimates the amount of data for encoding each macroblock of the pictures, based on the data provided by the hardware accelerator 520 and the spatial from original comparator 525, and whether the content in the macroblock is perceptually sensitive. The pre-encoder 515 estimates the amount of data for encoding the picture 115, from the estimates of the amounts of data for encoding each macroblock of the picture.

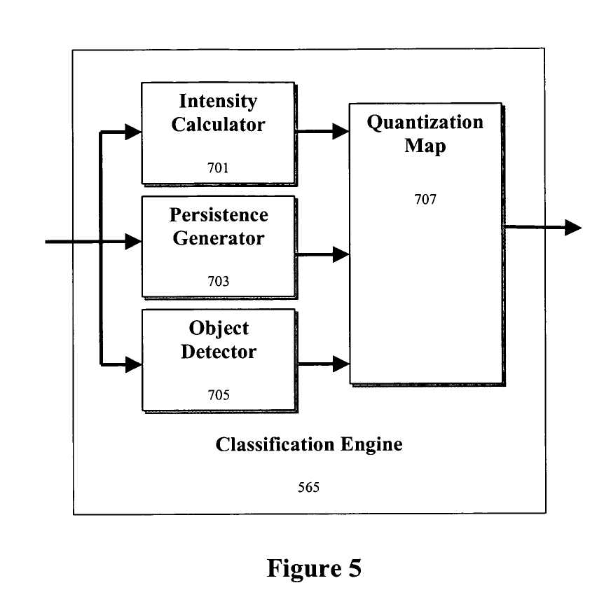

The pre-encoder 515 comprises a complexity engine 560 that estimates the amount of data for encoding the pictures, based on the results of the hardware accelerator 520 and the spatial from original comparator 525. The pre-encoder 515 also comprises a classification engine 565. The classification engine 565 classifies intensity, persistence and certain content from the pictures that is perceptually sensitive, such as human faces, where additional data for encoding is desirable. The classification engine 565 is described in further detail with respect to FIG. 5.

Where the classification engine 565 classifies certain content from pictures 115 to be perceptually sensitive, the classification engine 565 indicates the foregoing to the complexity engine 560. The complexity engine 560 can adjust the estimate of data for encoding the pictures 115. The complexity engine 565 provides the estimate of the amount of data for encoding the pictures by providing an amount of data for encoding the picture with a nominal quantization parameter Qp. It is noted that the nominal quantization parameter Qp is not necessarily the quantization parameter used for encoding pictures 115.

The picture rate controller 505 provides a target rate to the macroblock rate controller 510. The motion estimator 535 searches the vicinities of areas in the reconstructed predicted picture that correspond to the candidate blocks CB, for predicted blocks that are similar to the blocks in the plurality of pictures.

The search for the predicted blocks by the motion estimator 535 can differ from the search by the hardware accelerator 520 in a number of ways. For example, the reconstructed predicted picture and the picture can be full scale, whereas the hardware accelerator 520 searches original predicted pictures and pictures that are reduced scale. Additionally, the blocks can be smaller partitions of the blocks by the hardware accelerator 520. For example, the hardware accelerator 520 can use a 16×16 block, while the motion estimator 535 divides the 16×16 block into smaller blocks, such as 4×4 blocks. Also, the motion estimator 535 can search the reconstructed predicted picture with ¼ pixel resolution.

The spatial predictor 545 performs the spatial predictions for blocks. The mode decision & transform engine 540 determines whether to use spatial encoding or temporal encoding, and calculates, transforms, and quantizes the prediction error E from the predicted block. The complexity engine 560 indicates the complexity of each macroblock at the macroblock level based on the results from the hardware accelerator 520 and the spatial from original comparator 525, while the classification engine 565 indicates whether a particular macroblock contains sensitive content. Based on the foregoing, the complexity engine 560 provides an estimate of the amount of bits that would be required to encode the macroblock. The macroblock rate controller 510 determines a quantization parameter and provides the quantization parameter to the mode decision & transform engine 540. The mode decision & transform engine 540 comprises a quantizer Q. The quantizer Q uses the foregoing quantization parameter to quantize the transformed prediction error.

The mode decision & transform engine 540 provides the transformed and quantized prediction error E to the entropy encoder 555. Additionally, the entropy encoder 555 can provide the actual amount of bits for encoding the transformed and quantized prediction error E to the picture rate controller 505. The entropy encoder 555 codes the quantized prediction error E into bins. The entropy encoder 555 converts the bins to entropy codes. The actual amount of data for coding the macroblock can also be provided to the picture rate controller 505.

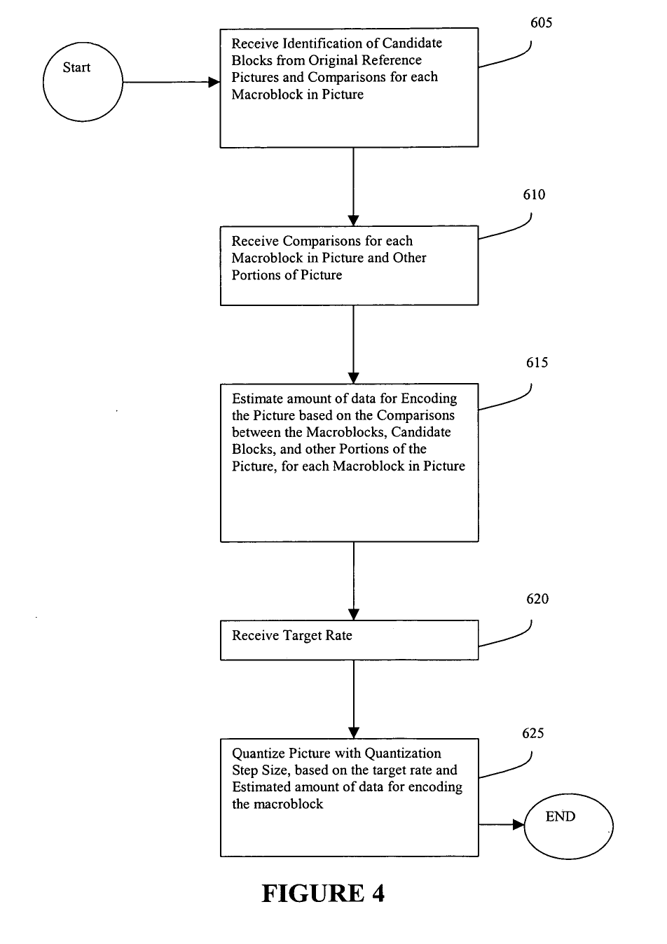

Referring now to FIG. 4, there is illustrated a flow diagram for encoding video data in accordance with an embodiment of the present invention. At 605, an identification of candidate blocks from original predicted pictures and comparisons are received for each macroblock of the picture from the hardware accelerator 520. For each macroblock, the hardware accelerator 520 provides the best vector that predicts the macroblock and quality metrics, which indicate the quality of the prediction for each reference picture. At 610, comparisons for each macroblock of the picture to other portions of the picture are received from the spatial from original comparator 525. At 615, the pre-encoder 515 estimates the amount of data for encoding the picture based on the comparisons of the candidate blocks to the macroblocks, and other portions of the picture to the macroblocks. The process described above is for a single macroblock. The estimated relative bit allocations for each macroblock may be calculated and the sum of the estimated relative bit allocations is the relative bit allocation for the picture.

At 620, the macroblock rate controller 510 receives a target rate for encoding the picture. At 625, transformation values associated with each macroblock of the picture 115 are quantized with a quantization step size, wherein the quantization step size is based on the target rate and the estimated amount of data for encoding the macroblock.

The embodiments described herein may be implemented as a board level product, as a single chip, application specific integrated circuit (ASIC), or with varying levels of the decoder system integrated with other portions of the system as separate components.

The degree of integration of the encoder system may primarily be determined by speed and cost considerations. Because of the sophisticated nature of modern processor, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware. For example, the macroblock rate controller 510, pre-encoder 515, spatial from original comparator 525, activity metric calculator 530, motion estimator 535, mode decision and transform engine 540, and entropy encoder 555 can be implemented as firmware or software under the control of a processing unit in the encoder 110. The picture rate controller 505 can be firmware or software under the control of a processing unit at the master 105. Alternatively, the foregoing can be implemented as hardware accelerator units controlled by the processor.

Referring now to FIG. 5, a block diagram of an exemplary video classification engine is shown. The classification engine 565 comprises an intensity calculator 701, a persistence generator 703, a object detector 705, and a quantization map 707.

The intensity calculator 701 can determine the dynamic range of the intensity by taking the difference between the minimum luma component and the maximum luma component in a macroblock.

For example, the macroblock may contain video data having a distinct visual pattern where the color and brightness does not vary significantly. The dynamic range can be quite low, and minor variations in the visual pattern are difficult to capture without the allocation of enough bits during the encoding of the macroblock. An indication of how many bits you should be adding to the macroblock can be based on the dynamic range. A low dynamic range scene may require a negative QP shift such that more bits are allocated to preserve the texture and patterns.

A macroblock that contains a high dynamic range may also contain sections with texture and patterns, but the high dynamic range can spatially mask out artifacts in the encoded texture and patterns. Dedicating fewer bits to the macroblock with the high dynamic range can result in little if any visual degradation.

Scenes that have high intensity differentials or dynamic ranges can be given fewer bits comparatively. The perceptual quality of the scene can be preserved since the fine detail, that would require more bits, may be imperceptible. A high dynamic range will lead to a positive QP shift for the macroblock.

For lower dynamic range macroblocks, more bits can be assigned. For higher dynamic range macroblocks, fewer bits can be assigned.

The human visual system can perceive intensity differences in darker regions more accurately than in brighter regions. A larger intensity change is required in brighter regions in order to perceive the same difference. The dynamic range can be biased by a percentage of the lumma maximum to take into account the brightness of the dynamic range. This percentage can be determined empirically. Alternatively, a ratio of dynamic range to lumma maximum can be computed and output from the intensity calculator 701.

The persistence generator 703 can estimate the persistence of a macroblock based on the sum of absolute difference (SAD) from motion estimation, the consistency of neighboring motion vectors and the dynamic range of the luma component. A high persistence can have a relatively low SAD since it can be well predicted. Elements of a scene that are persistent can be more noticeable. Whereas, elements of a scene that appear for a short period may have details that are less noticeable. More bits can be assigned when a macroblock is persistent. Macroblocks that persists for several frames can be assigned more bits since errors in those macroblocks are going to be more easily perceived.

A block of pixels can be declared part of a target region by the object detector 705 if enough of the pixels fall within a statistically determined range of values. For example in an 8×8 block of pixels in which skin is being detected, an analysis of color on a pixel-by-pixel basis can be used to determine a probability that the block can be classified as skin.

When the object detector 705 has classified a target object, quantization levels can be adjusted to allocate more or less resolution to the associated block(s). For the case of skin detection, a finer resolution can be desired to enhance human features. The quantization parameter (QP) can be adjusted to change bit resolution at the quantizer in a video encoder. Shifting QP lower will add more bits and increase resolution. If the object detector 705 has detected a target object that is to be given higher resolution, the QP of the associated block in the quantization map 707 will be decreased. If the object detector 705 has detected a target object that is to be given a lower resolution, the QP of the associated block in the quantization map 707 will be increased. Target objects that can receive lower resolution may include trees, sky, clouds, or water if the detail in these objects is unimportant to the overall content of the picture.

The classification engine 565 can determine relative bit allocation. The classification engine 565 can elect a relative QP shift value for every macroblock during pre-encoding. Relative to a nominal QP the current macroblock can have a QP shift that indicates encoding with quantization level that is deviated from an average. A lower QP (negative QP shift) indicates more bits are being allocated, a higher QP (positive QP shift) indicates less bits are being allocated.

The QP shift for intensity, persistence, and block detection can be independently calculated. The quantization map 707 can be generated a priori and can be used by a rate controller during the encoding of a picture. When coding the picture, a nominal QP will be adjusted to try to stay on a desired “rate profile”, and the quantization map 707 can provide relative shifts to the nominal QP.

When encoding video, a target bit rate may be desired. However, not all pictures should be allocated the same number of bits. For example, the number of bits per picture will vary by type of picture (I, P or B) and by picture content or complexity. In a distributed system where many parallel processors are used to encode pictures, it is desirable to determine bit allocation prior to encoding the picture. To determine bit allocation a-prior, bit estimation and allocation may be performed in a pipelined fashion before encoding.

Video quality is a function of a quantization parameter (QP). A constant QP yields roughly a constant peak signal to noise ratio (PSNR) in the reconstructed picture.

To figure out the relative bit allocations of the pictures, a QP offset map and an estimate of the number of bits at each QP is determined.

The QP offset map classifies areas to determine which parts of pictures should be encoded at higher quality and which can be encoded at a lower quality. The QP offset map at the macroblock level is applied as the encoding and bit estimates are made.

The estimate of the number of bits needed to encode the picture at a fixed base QP adjusted by the classification map may be based on open loop spatial estimation and coarse motion estimation. The spatial mode and resulting prediction error (or optionally transformed and quantized prediction error) may be used to estimate the number of bits it would take to spatially encode the macroblock. The error resulting from the coarse motion estimation of the original pictures (or optionally, the transformed and quantized prediction error from this operation) may be used to estimate the number of bits it would take to spatially encode the macroblock. The smaller of these two estimates is used for the macroblock. The sum of all the smallest final estimates for all the macroblocks is the estimate for the picture. The rate control allocates bits in proportion to the variations in estimates such that the desired bit rate is obtained.

The rate control also estimates the base QP for the picture based on the estimated number of bits at the tested QP and adapts the base QP to what is actually happening and also generates a map at the macroblock level of where the bits should go in the picture. The macroblock level rate control starts with the base QP and adds the offset map generated by the classification engine and a feedback QP to generate the final QP to use when encoding each macroblock. The feedback QP offset is a function of how the encoding rate is relative to the sum of the target bit allocations in the macroblock level rate map.

The open loop spatial estimation does not require the actual reconstructed data. Therefore, the open loop spatial estimation breaks the dependence of one picture on another at the pre-encode stage. During the final encoding, the real spatial encoding requires the actual reconstructed data.

In a similar way, the pre-encoding motion estimation may be performed on the original data to break the dependence on reconstructed data to generate an estimate of how to allocate bits. The final encoding differs from the estimates in the following ways: the final choice of modes includes evaluation of smaller partition sizes in inter coding; the mode selection may involve actual encoding to test the actual numbers of bits; and the predicted data is always from reconstructed pictures.

It will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on the AVC encoding standard, the invention can be applied to a video data encoded with a wide variety of standards.

Therefore, it is intended that the present invention not be limited to the particular embodiment disclosed, but that the present invention will include all embodiments falling within the scope of the appended claims.

1. A method for controlling the allocation of coded bits when encoding a picture, said method comprising:
classifying all portions of the picture;
estimating a relative quantization parameter for encoding the portions of the picture;
receiving a nominal quantization parameter and target bit budget for encoding the picture; and
lossy encoding the portion of the picture, based on the nominal quantization parameter and the relative quantization parameter for encoding the portion of the picture.

2. The method of claim 1, wherein estimating a relative quantization parameter for encoding each portion of the picture further comprises:
measuring a persistence of the portions of the picture.

3. The method of claim 2, wherein the relative quantization parameter indicates a finer quantization when the persistence is relatively long.

4. The method of claim 1, wherein estimating a relative quantization parameter for encoding the portion of the picture further comprises:
measuring an intensity of the portion of the picture.

5. The method of claim 4, wherein the relative quantization parameter indicates a finer quantization when the intensity is relatively low.

6. The method of claim 4, wherein the relative quantization parameter indicates a coarser quantization when the intensity is relatively high.

7. The method of claim 1, wherein estimating a relative quantization parameter for encoding the portion of the picture further comprises:
generating a detection metric based on a statistical probability that the portion of the picture contains an object with a perceptual quality.

8. The method of claim 7, wherein the relative quantization parameter indicates a finer quantization when the perceptual quality of the object is important to a viewer of the picture and a coarser quantization when the perceptual quality of the object is less important to the viewer of the picture.

9. A computer system for encoding a picture, said system comprising:
a processor for executing a plurality of instructions;
a memory for storing the plurality of instructions, wherein execution of the plurality of instructions by the processor causes:
classifying portions of the picture;
estimating a relative quantization parameter for encoding the portions of the picture;
receiving a nominal quantization parameter and target bit budget for encoding the picture; and
lossy encoding the portion of the picture, based on the nominal quantization parameter and the relative quantization parameter for encoding the portion of the picture.

10. The computer system of claim 9, wherein estimating the relative quantization parameter for encoding the portion of the picture further comprises:
determining a persistence of the portion of the picture.

11. The computer system of claim 9, wherein execution of the plurality of instructions by the processor causes feeding back to lossy encoding information to aid in estimating another relative quantization parameter.

12. The computer system of claim 10, wherein the relative quantization parameter indicates a finer quantization when the persistence is relatively long.

13. The computer system of claim 9, wherein estimating a relative quantization parameter for encoding the portion of the picture further comprises:
measuring an intensity of the portion of the picture.

14. The computer system of claim 13, wherein the relative quantization parameter indicates a finer quantization when the intensity is relatively low.

15. The computer system of claim 9, wherein estimating a relative quantization parameter for encoding the portion of the picture further comprises:
generating a detection metric based on a statistical probability that the portion of the picture contains an object with a perceptual quality.

16. The method of claim 15, wherein the relative quantization parameter indicates a finer quantization when the perceptual quality of the object is important to a viewer of the picture.

17. A system for encoding video data, said system comprising:
a classification engine for classifying portions of the picture;
a quantization map for storing a relative quantization parameter for encoding the portions of the picture
a lossy compressor for receiving a nominal quantization parameter and lossy compressing the picture, wherein a compression rate is based on the quantization map and the nominal quantization parameter.

18. The system of claim 17, wherein the system further comprises:
an intensity calculator for measuring an intensity of the portion of the picture, wherein the relative quantization parameter indicates a finer quantization when the intensity is relatively low.

19. The system of claim 17, wherein the system further comprises:
a persistence generator for measuring a persistence of the portion of the picture, wherein the relative quantization parameter indicates a finer quantization when the persistence is relatively long.

20. The system of claim 17, wherein the system further comprises:
a object detector for generating a detection metric based on the portion of the picture, wherein the relative quantization parameter indicates a finer quantization when an object of perceptual significance is detected according to the detection metric.
